(19) United States
(12) Patent Application Publication
(10) Pub. No.: US 2006/0057444 A1
(43) Pub. Date: Mar. 16, 2006

(54) Fuel processing apparatus and method and fuel cell power generation system

(75) Inventors: Yuto Takagi, Tokyo (JP); Qingquan Su, Tokyo (JP)

Correspondence Address: FOLEY AND LARDNER LLP;SUITE 500, 3000 K STREET NW, WASHINGTON, DC, 20007, US

(73) Assignee: EBARA Ballard Corporation

(21) Appl. No.: 10/938,875

(22) Filed: Sep. 13, 2004

(51) Int. Cl. H01M 8/06; C01B 3/26; C01B 3/16; B01J 8/04

(52) U.S. Cl. 429/20; 423/652; 423/656; 422/190; 422/198

(57) ABSTRACT

A fuel processing apparatus capable of shortening startup time is provided. The fuel processing apparatus comprises: a reformer catalyst section 21 filled with a reformer catalyst for reforming a hydrocarbon-based fuel h into a reformate g containing hydrogen as a main ingredient, a shift converter catalyst section 22 filled with a shift converter catalyst for shift-converting carbon monoxide contained in the reformate, a selective oxidation catalyst section 23 filled with a selective oxidation catalyst for selectively oxidizing carbon monoxide contained in the reformate after the shift-converting, a burner section 25 for receiving and combusting the fuel to heat the reformer catalyst section, and discharging the combusted exhaust gas q, a combusted exhaust gas passage 28 through which flows the combusted exhaust gas or the fuel n that has not been combusted in the burner section, and a combustion catalyst section 26 formed in the combusted exhaust gas passage and filled with a combustion catalyst; and the combustion catalyst section being located in the vicinity of the shift converter catalyst section 22 or the selective oxidation catalyst section.

### BACKGROUND OF THE INVENTION

1. Technical Field

This invention relates to a fuel processing apparatus, a fuel processing method, and a fuel cell power generation system provided with the fuel processing apparatus and is more particularly concerned with those in which a startup time is controlled to shorten.

2. Related Art

Conventionally, a fuel cell power generation system comprises: a fuel processing apparatus for processing a hydrocarbon-based fuel into a reformate (reformed gas); a fuel cell stack for generating electricity using the reformate; and a control section for controlling the entire system. The fuel processing apparatus comprises: a reformer catalyst section where reaction occurs to reform the hydrocarbon-based fuel; a shift converter catalyst section where reaction occurs to shift-convert the reformate; a selective oxidation catalyst section where reaction occurs to selectively oxidize carbon monoxide contained in the reformate; and a burner section for combusting a combustion fuel to heat the shift converter catalyst section or the like, for providing heat required for the shift converter reaction or the like.

In order to cause the reformer reaction to occur, the reformer catalyst section is required to reach a specified temperature. Also, in order to cause the shift converter reaction and the selective oxidation reaction, the shift converter catalyst section and the selective oxidation catalyst section are required to reach specified temperatures, respectively. When starting up the fuel cell power generation system, due to the configuration of the fuel processing apparatus, the temperature in the reformer catalyst section can be raised within a short period of time by combustion in the burner section. However, temperature rise in the shift converter catalyst section and the selective oxidation catalyst section often used to be the bottleneck in shortening the startup time.

It has been therefore a common practice to combust the reformate in the burner section and wait, in the so-called hot-hold state, until the shift converter catalyst section and the selective oxidation catalyst section reach certain specified temperatures.

In the hot-hold state, however, not only no electric output is obtained from the fuel cell stack but the amount of the reformate produced in the reformer catalyst section is small, and the flow rate of the reformate in the shift converter catalyst section and the selective oxidation catalyst section is low.

Therefore, the flow rate of heating medium for heating the shift converter catalyst section and the selective oxidation catalyst section with the heat given from the reformer catalyst section is low, and the amount of heat given to the shift converter catalyst section and the selective oxidation catalyst section is small, resulting in a slow temperature rise of the shift converter catalyst section and the selective oxidation catalyst section, that is, a long startup time. There has been also a method of heating at least one of the shift converter catalyst section and the selective oxidation catalyst section during the startup process using an electric heater. However, although the startup time can be shortened, there are disadvantages such as increased startup power consumption and high startup costs.

Therefore, it is an object of this invention to provide: a fuel processing apparatus, a fuel processing method, and a fuel cell power generation system that make it possible to shorten the startup time, and to reduce the startup energy consumption.

### SUMMARY OF THE INVENTION

In order to achieve the above object, a fuel processing apparatus according to this invention, as shown for example in FIG. 1, comprises: a reformer catalyst section 21 filled with a reformer catalyst for reforming a hydrocarbon-based fuel h into a reformate g containing hydrogen as a main ingredient thereof; a shift converter catalyst section 22 filled with a shift converter catalyst for shift-converting carbon monoxide contained in the reformate g; a selective oxidation catalyst section 23 filled with a selective oxidation catalyst for selectively oxidizing carbon monoxide contained in the reformate g after the shift-converting; a burner section 25 for receiving and combusting a combustion fuel n, to heat the reformer catalyst section 21, and discharging a combusted exhaust gas q; a combusted exhaust gas passage 28 through which flows the combusted exhaust gas q or the combustion fuel n that has not been combusted in the burner section 25; and a combustion catalyst section 26 formed in the combusted exhaust gas passage 28 and filled with a combustion catalyst for combusting the combustion fuel n, and the combustion catalyst section 26 is located in the vicinity of the shift converter catalyst section 22 or the selective oxidation catalyst section 23.

With the above configuration including the reformer catalyst section 21, the shift converter catalyst section 22, the selective oxidation catalyst section 23, the burner section 25, the combusted exhaust gas passage 28, and the combustion catalyst section 26, it is possible during startup operation not only to combust the combustion fuel n in the burner section 25 but also to combust the combustion fuel n, that has been supplied to but not combusted in the burner section 25, with the combustion catalyst in the combustion catalyst section 26. Because the combustion catalyst section 26 is placed in the vicinity of the shift converter catalyst section 22 or the selective oxidation catalyst section 23, it is possible, in addition to heating the reformer catalyst section 21 with the heat of combustion in the burner section 25, to heat the shift converter catalyst section 22 or the selective oxidation catalyst section 23 with the heat of combustion in the combustion catalyst section 26. Therefore, it is not only possible to raise the temperature in the reformer catalyst section 21 (same meaning as the temperature of the reformer catalyst, hereinafter too) but also to raise the temperature within a short period of time in the shift converter catalyst section 22 (same meaning as the temperature of the shift converter catalyst, hereinafter too) or the selective oxidation catalyst section 23 (same meaning as the temperature of the selective oxidation catalyst, hereinafter too). Moreover, because not only the reformer catalyst section 21 but also the shift converter catalyst section 22 or the selective oxidation catalyst section 23 are heated, it is possible to prevent the burner section 25 and the reformer catalyst section 21 from being heated unevenly, to avoid excessive heating of the burner section 25 and the reformer catalyst section 21, and to raise the temperature of the shift converter catalyst section 22 or the selective oxidation catalyst section 23 within a short period of time. Therefore, it is possible to shorten the startup time of the fuel processing apparatus 2 and reduce energy consumed during the startup time.

The combustion fuel n is typically at least one of: a reformate g (A1) coming out of the selective oxidation catalyst section 23, a hydrocarbon-based fuel h (B1) of the same origin as the hydrocarbon-based fuel supplied to the reformer catalyst section 21, a hydrocarbon-based fuel n (C1) of an origin different from that of the hydrocarbon-based fuel h supplied to the reformer catalyst section 21, and an anode-off gas f (D1) produced in the fuel cell stack 3 which generates electricity using the reformate g supplied from the fuel processing apparatus 2. For example, it may be A1 only (combusting the reformate g only in the burner section 25), a mixture of A1 and C1 (mixed combustion of the reformate g and the hydrocarbon-based fuel n in the burner section 25), or a mixture of C1 and D1 (mixed combustion of the anode-off gas f and the hydrocarbon-based fuel n in the burner section 25).

In addition, the fuel processing apparatus can be, as shown for example in FIG. 4, a fuel processing apparatus wherein the combustion fuel is a hydrocarbon-based fuel and the reformate g coming out of the selective oxidation catalyst section 23; and the combustion catalyst is capable of combusting the hydrocarbon-based fuel or hydrogen.

With the above configuration, it is possible to supply to and combust in the burner section 25 the hydrocarbon-based fuel n and the reformate g coming out of the selective oxidation catalyst section 23, and combust in the combustion catalyst section 26 the hydrocarbon-based fuel n or the reformate g which has not been combusted in the burner section 25. The combustion catalyst section 26 is preferably capable of combusting the hydrocarbon-based fuel n and the reformate g. For example, it is possible to make the air ratio too small in the burner section 25 by increasing the flow rate of the hydrocarbon-based fuel or the reformate g supplied to the burner section 25 relative to the flow rate of combustion air k4 supplied to the burner section 25, to bring about an imperfect combustion state in the burner section 25, and to combust the noncombusted hydrocarbon-based fuel or reformate g in the combustion catalyst section 26. For example, it is possible to cause extinction in the burner section 25 with too great an air ratio by reducing the flow rate of the hydrocarbon-based fuel or the reformate g supplied to the burner section 25 relative to the flow rate of combustion air k4, and to combust all the hydrocarbon-based fuel and all the reformate g in the combustion catalyst section 26. Causing combustion in the combustion catalyst section 26 as described above makes it possible to use the hydrocarbon-based fuel or the reformate g as a heat source for heating the shift converter catalyst section 22 and the selective oxidation catalyst section 23.

Combustion heat amount of the hydrocarbon-based fuel n or the reformate g may be used to heat not only the burner section 25 and the reformer catalyst section 21 but also the shift converter catalyst section 22 or the selective oxidation catalyst section 23, so as to avoid excessive temperature rise in the burner section 25 and the reformer catalyst section 21 and to raise the temperature in the shift converter catalyst section 22 or the selective oxidation catalyst section 23 within a short period of time. Therefore, it is possible to shorten the startup time of the fuel processing apparatus 2 and to reduce energy consumed during the startup time.

Moreover, the fuel processing apparatus can, as shown for example in FIG. 6, comprise a catalyst combustion air supply section 9 for supplying combustion air k5 for the combustion catalyst to the upstream side of the combustion catalyst section 26 in the combusted exhaust gas passage 28.

With the above configuration including the catalyst combustion air supply section 9, it is possible to feed the combustion air k5 for the combustion catalyst into the combustion catalyst section 26 by supplying the combustion air k5 to the upstream side of the combustion catalyst section 26 to cause combustion of the combustion fuel, the reformate, or the hydrocarbon-based fuel in the combustion catalyst section 26, so that combustion occurs simultaneously in the burner section 25 and the combustion catalyst section 26. In this way the startup time is further shortened.

Moreover, the above fuel processing apparatus can be, as shown for example in FIG. 1, a fuel processing apparatus wherein the combustion catalyst section 26 has: an outlet 26A for the combusted exhaust gas q to come out; and a combustion catalyst temperature detecting section 32 disposed at the outlet 26A to detect the temperature of the combustion catalyst.

With the above configuration including the combustion catalyst temperature detecting section 32, it is possible to detect the temperature of the combustion catalyst at the outlet 26A of the combustion catalyst section 26. Because the temperature of the combustion catalyst is detected, it is possible to control so as to prevent the combustion catalyst itself from deteriorating due to excessive temperature rise of the combustion catalyst section 26, or to prevent the shift converter catalyst or the selective oxidation catalyst from deteriorating due to excessive temperature rise of the shift converter catalyst section 22 or the selective oxidation catalyst section 23 located in the vicinity of the combustion catalyst section 26.

In order to achieve the above object, a fuel cell power generation system 1 according to this invention, as shown for example in FIG. 1, comprises: the above-mentioned fuel processing apparatus 2; and a fuel cell stack 3 for generating electricity using the reformate g having passed through the selective oxidation catalyst section 23.

With the above configuration including the fuel processing apparatus 2 and the fuel cell stack 3, it is possible to start up the fuel cell power generation system 1 and generate electricity within a short period of time, with a small amount of startup energy consumption, in a stabilized manner.

In order to achieve the above object, a fuel processing method according to this invention, comprises: a reformer step of reforming a hydrocarbon-based fuel into a reformate containing hydrogen as a main ingredient thereof; a shift converter step of shift-converting carbon monoxide contained in the reformate; a selective oxidation step of selectively oxidizing carbon monoxide contained in the reformate after the shift converter step; a first combustion step of supplying a combustion fuel to a burner section, and combusting the combustion fuel using combustion air in the burner section to provide heat required for the reformer step; and a second combustion step of combusting, using combustion air, the combustion fuel having passed through but not combusted in the burner section to provide heat required for the shift converter step or the selective oxidation step.

With the above configuration, by adjusting mainly at the startup of the fuel processing apparatus the combustion heat amount given as the heat necessary for the reformer process to the reformer catalyst section 21 in the first combustion process, the combustion heat amount given as the heat necessary for the shift converter process to the shift converter catalyst section 22 in the second combustion process, or the combustion heat amount given as the heat necessary for the selective oxidation process to the selective oxidation catalyst section 23 in the second combustion process, it is possible: to prevent uneven heating of the reformer catalyst section 21, to avoid excessive temperature rise of the reformer catalyst section 21, and to raise the temperature of the shift converter catalyst section 22 or the selective oxidation catalyst section 23 within a short period of time. Therefore, it is possible to shorten the startup time of the fuel processing apparatus 2 and reduce energy consumed during the startup time.

In addition, as for the fuel processing method, in the first combustion step, imperfect combustion can be caused to occur by supplying combustion air so that an air ratio results to be smaller than 1; and in the second combustion step, the fuel that has been imperfectly combusted in the first combustion step can be combusted perfectly by supplying combustion air so as to result in the air ratio that permits perfect combustion to occur.

With the above configuration, by setting air ratios smaller than 1 and for causing perfect combustion in the first combustion process and the second combustion process, respectively, mainly during the startup of the fuel processing apparatus, it is possible to produce sufficiently large amount of heat not only in the first combustion process but in the second combustion process, to prevent uneven heating of the reformer catalyst section 21, to prevent the temperature of the reformer catalyst section 21 from rising excessively, and to raise the temperature of the shift converter catalyst section 22 or the selective oxidation catalyst section 23 within a short period of time. Besides, with this configuration, it is possible to carry out the first combustion process and the second combustion process simultaneously, to heat the reformer catalyst section 21, the shift converter catalyst section 22 and the selective oxidation catalyst section 23 simultaneously during the startup time in a well-balanced manner, and to raise the temperature of the entire fuel processing apparatus within a short period of time and shorten the startup time.

Moreover, as for the fuel processing method, in the first combustion step, a combustion fuel containing at least one of fluids: an anode off-gas produced in a step of generating electricity using the reformate having undergone the selective oxidation step, the reformate having undergone the selective oxidation step, and a hydrocarbon-based fuel, can be supplied, extinction can be caused to occur in the first combustion step by increasing the flow rate of combustion air or by decreasing the flow rate of the combustion fuel containing the at least one of the fluids, the first combustion step can be stopped and the second combustion step can be started, and in the second combustion step the combustion fuel containing the at least one of the fluids can be combusted using the combustion catalyst; and then the supply of the combustion fuel can be halted, the supply of the combustion air can be maintained, then the supply of the combustion fuel containing the at least one of the fluids can be supplied again, and the first combustion step can be started. Then the above-mentioned steps can be repeated.

With the above configuration, because the first and second combustion processes are switched in time sequence, and the combustion reaction does not occur simultaneously in the first and second combustion processes, it is possible to carry out two combustion processes with a single combustion air supply system. Therefore, it is possible: to heat the reformer catalyst section, the shift converter catalyst section, and the selective oxidation catalyst section in a well-balanced manner, to shorten the startup time, and to reduce energy consumed during the startup time while retaining simplicity in configuration.

The basic Japanese Patent Application No. 2002-339711 filed on Nov. 22, 2002 is hereby incorporated in its entirety by reference into the present application.

The present invention will become more fully understood from the detailed description given hereinbelow. The other applicable fields will become apparent with reference to the detailed description given hereinbelow. However, the detailed description and the specific embodiment are illustrated of desired embodiments of the present invention and are described only for the purpose of explanation. Various changes and modifications will be apparent to those ordinary skilled in the art on the basis of the detailed description.

The applicant has no intention to give to public any disclosed embodiments. Among the disclosed changes and modifications, those which may not literally fall within the scope of the present claims constitute, therefore, a part of the present invention in the sense of doctrine of equivalents.

### BRIEF DESCRIPTION OF DRAWINGS

FIG. 1 is a block diagram, showing a configuration of a fuel cell power generation system of a first embodiment according to the invention.

FIG. 2 is a block diagram, showing a configuration of a reformer fuel supply section and others of FIG. 1.

FIG. 3 is a graph, showing a startup operation of the fuel cell power generation system of FIG. 1.

FIG. 4 is a block diagram, showing a configuration of a fuel cell power generation system of a second embodiment according to the invention.

FIG. 5 is a block diagram, showing a configuration of a reformate bypass section of FIG. 4.

FIG. 6 is a block diagram, showing a configuration of a fuel cell power generation system of a third embodiment according to the invention.

FIG. 7 is a block diagram, showing a configuration of a fuel cell power generation system of a fourth embodiment according to the invention.

### DETAILED DESCRIPTION OF PREFERRED EMBODIMENTS

With reference to the appended drawings, embodiments of the invention are described hereinafter. Same components or counterparts in different drawings are represented by the same reference numerals or symbols, and the same explanation is not repeated.

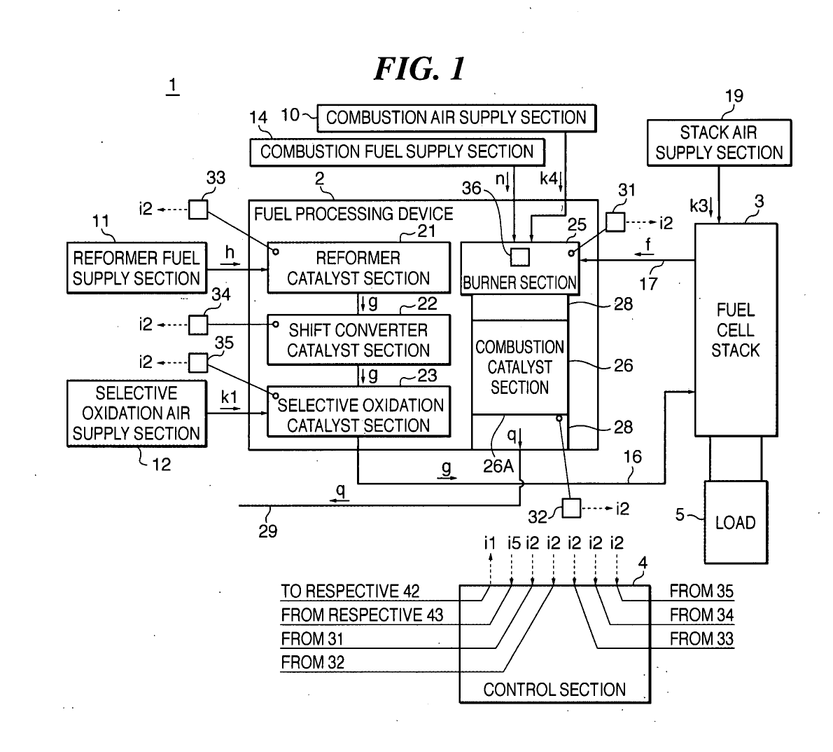

FIG. 1 is a block diagram, showing a configuration of a fuel cell power generation system 1 of a first embodiment according to the invention. The fuel cell power generation system 1 is constituted by including: a fuel processing apparatus 2, a fuel cell stack 3 which is a solid polymer electrolyte fuel cell, a control section 4, a reformer fuel supply section 11 for supplying a reformer fuel h as a hydrocarbon-based fuel, a selective oxidation air supply section 12 for supplying a selective oxidation air k1, a combustion fuel supply section 14 for supplying a combustion fuel n as a fuel for combustion (combustion fuel) or a hydrocarbon-based fuel, a combustion air supply section 10 for supplying a combustion air k4, a first reformate transport line 16 for transporting a reformate g, a first off-gas transport line 17 for transporting an off-gas f as an anode off-gas, a stack air supply section 19 for supplying a stack air k3, and a combusted exhaust gas transport line 29 for transporting the combusted exhaust gas q. Incidentally, the hydrocarbon-based fuel h, the selective oxidation air k1, the combustion fuel n, the combustion air k4, and the stack air k3 are collectively called as a utility fluid. Besides, the hydrocarbon-based fuel is typically a city gas g (13A with main ingredients of methane, ethane, propane, butane, etc.).

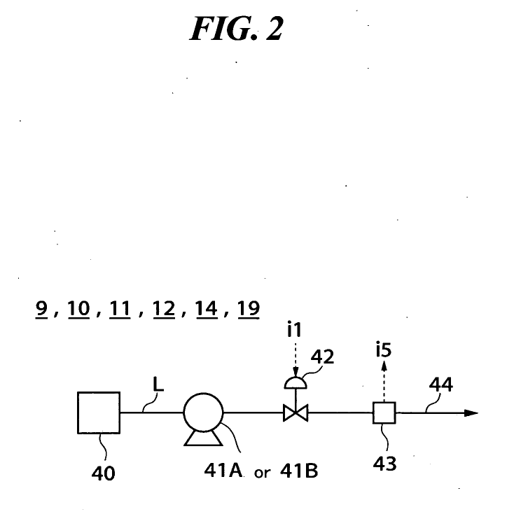

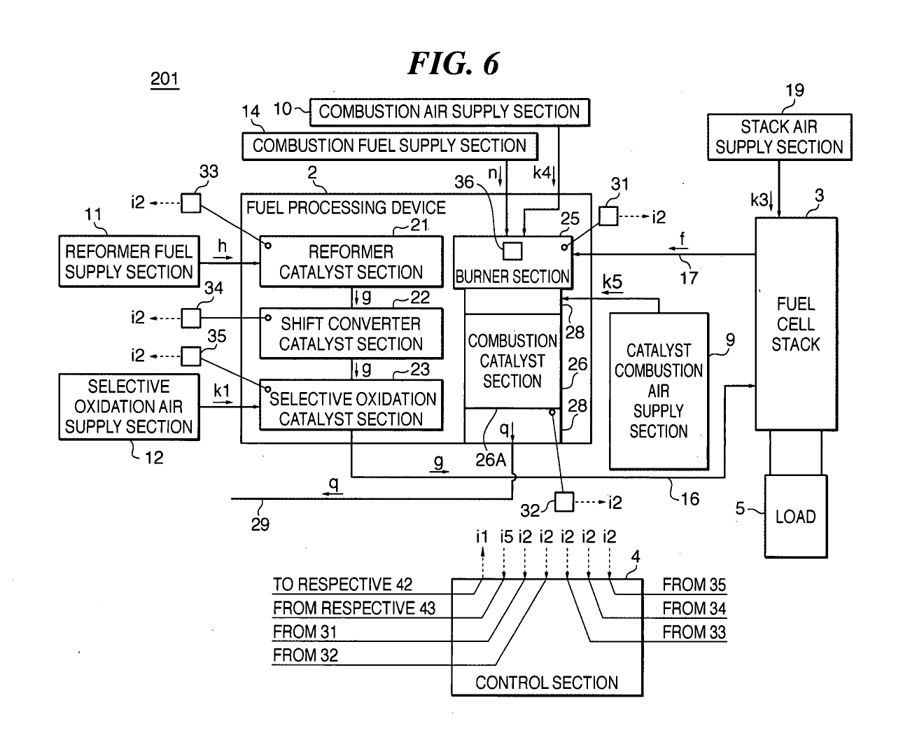

As shown in FIG. 2, the reformer fuel supply section 11 (FIG. 1), the selective oxidation air supply section 12 (FIG. 1), the combustion fuel supply section 14 (FIG. 1), the combustion air supply section 10 (FIG. 1), the catalyst combustion air supply section 9 (FIG. 6) to be described later, and the stack air supply section 19 (FIG. 1) are connected to a supply source 40 for supplying the utility fluid L, and respectively constituted by including: a blower 41A (for gas) or a pump 41B (for liquid) as a device for pressuring the utility fluid L, a control valve 42 as a fluid flow rate controlling device for controlling the flow rate of the utility fluid L, a flowmeter 43 for measuring the flow rate of the utility fluid L, and piping 44 for interconnecting these components. A flow rate control signal i1 for controlling the flow rate of the control valve 42 is individually sent from a control section 4 (FIG. 1) to each control valve 42. A flow rate signal i5 representing the flow rate measured is sent from each flowmeter 43 to the control section 4. The supply source 40 for air is usually the atmosphere.

Explanation is continued with reference to FIG. 1 again. The fuel processing apparatus 2 comprises: the reformer catalyst section 21 filled with reformer catalyst, the shift converter catalyst section 22 filled with shift converter catalyst for shift-converting carbon monoxide contained in the reformate g, the selective oxidation catalyst section 23 filled with selective oxidation catalyst for selectively oxidizing carbon monoxide contained in the reformate g after being shift-converted, the burner section 25, the combusted exhaust gas passage 28, the combustion catalyst section 26 placed in the combusted exhaust gas passage 28 and filled with combustion catalyst, and an igniter 36 placed in the burner section 25. The igniter 36 makes it possible to cause combustion in the burner section 25 into which the combustion fuel n and the combustion air k4 are supplied.

To the reformer catalyst section 21 is connected the reformer fuel supply section 11 which supplies the reformer fuel h to the reformer catalyst section 21. In the reformer catalyst section 21, reformer reaction occurs using the reformer catalyst to reform the supplied reformer fuel h into the reformate g containing a main ingredient of hydrogen (for example, about 70-75 mol % of hydrogen). In the shift converter catalyst section 22, a CO shift converter reaction of the reformate g occurs using the shift converter catalyst. To the selective oxidation catalyst section 23 is connected the selective oxidation air supply section 12 which supplies the selective oxidation air k1 to the selective oxidation catalyst section 23. In the selective oxidation catalyst section 23, selective oxidation of the carbon monoxide gas remaining in the reformate g occurs using the selective oxidation catalyst. To the burner section 25 are connected the combustion fuel supply section 14 and the combustion air supply section 10 to supply the combustion fuel n and the combustion air k4 respectively to the burner section 25. The burner section 25 causes the combustion fuel n and the off-gas f (to be described later) to mix with the combustion air k4 and combust to provide heat necessary for the reformer reaction and the shift converter reaction. To the burner section 25 is supplied mainly the combustion fuel n during the startup, and mainly the off-gas f during normal electric generation. Incidentally, the reformer fuel h and the combustion fuel n may be either gas or liquid.

The burner section 25 is connected to the combusted exhaust gas passage 28. The combusted exhaust gas passage 28 leads the combusted exhaust gas q produced in the burner section 25 by combusting the combustion fuel n or the off-gas f to the outside of the fuel processing apparatus 2. After exiting the fuel processing apparatus 2, the combusted exhaust gas q is transported through the combusted exhaust gas transport line 29 connected to the combusted exhaust gas passage 28.

The combustion catalyst section 26, capable of combusting hydrogen and hydrocarbon-based fuel, is disposed in the combusted exhaust gas passage 28. The combustion fuel n or the off-gas f that has remained noncombusted in the burner section 25 is led through the combusted exhaust gas passage 28 to the combustion catalyst section 26 and combusted there with the combustion catalyst.

A temperature detector 31 for detecting the temperature in the burner section 25 is provided in the burner section 25. A temperature detector 33 for detecting the temperature in the reformer catalyst section 21 is provided in the reformer catalyst section 21. A temperature detector 34 for detecting the temperature in the shift converter catalyst section 22 is provided in the shift converter catalyst section 22. A temperature detector 35 for detecting the temperature in the selective oxidation catalyst section 23 is provided in the selective oxidation catalyst section 23. A temperature detector 32 as a combustion catalyst temperature detecting section is provided at the outlet 26A of the combustion catalyst section 26 to detect the temperature of the combustion catalyst section 26 (the same meaning as the combustion catalyst temperature, hereinafter too). Temperatures detected with the temperature detectors 31, 32, 33, 34, and 35 are sent as respective temperature signals i2 to the control section 4.

The first reformate transport line 16 interconnects the selective oxidation catalyst section 23 of the fuel processing apparatus 2 and the fuel cell stack 3 to transport the reformate g from the selective oxidation catalyst section 23 to the fuel cell stack 3. The first off-gas transport line 17 interconnects the fuel cell stack 3 and the burner section 25 to transport the off-gas f, to be described later, from the fuel cell stack 3 to the burner section 25.

The fuel cell stack 3 has a multi-layer configuration in which solid polymer membranes (not shown) and separators(not shown) are placed alternately one over another, and generates electricity by causing electrochemical reaction between the reformate g and the stack air k3 supplied and produces the off-gas (unused reformate) h as well. Here, the off-gas f is the surplus reformate remaining after hydrogen is used for electric generation in the fuel cell stack 3. The off-gas f is the so-called hydrogen-rich gas, containing for example the rest 20% (mol %) of the hydrogen contained in the reformate g, if 80% (mol %) of the hydrogen is used for electric generation. The fuel cell stack 3 is electrically connected to a load 5 (any electric device).

The stack air supply section 19 is connected to the fuel cell stack 3 to supply stack air k3 to the fuel cell stack 3.

Next, functions of the fuel cell power generation system 1 are described with reference to FIGS. 1 and 2. The following functions are performed as controlled with the control section 4. The combustion fuel n transported with the blower 41A for the combustion fuel is supplied from the combustion fuel supply section 14 to the burner section 25 during the startup and assist-combustion in normal operation. The control valve 42 provided in the combustion fuel supply section 14, receiving a flow rate control signal i1 from the control section 4, is controlled to a specified opening to flow the combustion fuel n at a flow rate corresponding to the flow rate control signal i1. The flow rate of the combustion fuel n is measured with the flowmeter 43 for the combustion fuel. The measured flow rate is sent as a flow rate signal i5 to the control section 4. During normal operation, the off-gas f is supplied from the fuel cell stack 3 through the first off-gas transport line 17 to the burner section 25.

The combustion air k4 transported with the blower 41A for the combustion air is supplied from the combustion air supply section 10 to the burner section 25. The control valve 42 for the combustion air provided in the combustion air supply section 10, receiving a flow rate control signal i1 from the control section 4, is controlled to a specified opening to flow the combustion air k4 at a flow rate corresponding to the flow rate control signal i1. The flow rate of the combustion air k4 is measured with the flowmeter 43 for the combustion air. The measured flow rate is sent as a flow rate signal i5 to the control section 4. The combustion fuel n and the off-gas f are combusted in the burner section 25 under the supply of the combustion air k4.

The heat produced by combustion in the burner section 25 is used to raise the temperature of the reformer catalyst section 21, for heat for the reformer reaction in the reformer catalyst section 21, and to raise and maintain the temperature of the reformer catalyst (not shown) filled in the reformer catalyst section 21 at a specified temperature suitable for the reformer reaction therein. The heat that has heated the reformer catalyst is further transmitted through the fuel processing apparatus 2, or through the reformate g heated through the reformer catalyst, is given to the shift converter catalyst (not shown) filled in the shift converter catalyst section 22 and to the selective oxidation catalyst (not shown) filled in the selective oxidation catalyst section 23. However, the temperature rise of the shift converter catalyst and the selective oxidation catalyst by the combustion in the burner section 25 is little in comparison with the temperature rise of the reformer catalyst.

The reformer fuel h is transported with the blower 41A for the reformer fuel from the reformer fuel supply section 11 to the reformer catalyst section 21. The control valve 42 for the reformer fuel provided in the reformer fuel supply section 11, receiving a flow rate control signal i1 from the control section 4, is controlled to a specified opening to flow the reformer fuel h at a flow rate corresponding to the flow rate control signal i1. The flow rate of the reformer fuel h is measured with the flowmeter 43 for the reformer fuel. The measured flow rate is sent as a flow rate signal i5 to the control section 4.

In the reformer catalyst section 21, if the reformer fuel h is for example methane, it undergoes a steam reformer reaction expressed with an equation of CH₄+H₂O→CO+3H₂ with the reformer catalyst, to become a reformate g.

The reformate g is sent from the reformer catalyst section 21 to the shift converter catalyst section 22, and undergoes a shift converter reaction expressed with an equation of CO+H₂O→CO₂+H₂ with the shift converter catalyst. The reformate g is sent further from the shift converter catalyst section 22 to the selective oxidation catalyst section 23. The selective oxidation air k1 is transported with the blower 41A for the selective oxidation air and sent from the selective oxidation air supply section 12 to the selective oxidation catalyst section 23. The control valve 42 for the selective oxidation air provided in the selective oxidation air supply section 12, receiving a flow rate control signal i1 from the control section 4, is controlled to a specified opening to flow the selective oxidation air k1 at a flow rate corresponding to the flow rate control signal i1. The flow rate of the selective oxidation air k1 is measured with the flowmeter 43 for the selective oxidation air. The measured flow rate is sent as a flow rate signal i5 to the control section 4.

A CO gas remaining in the reformate g is selectively oxidized with the selective oxidation air k1 in the selective oxidation catalyst section 23 and undergoes a reaction expressed with an equation of CO+(½)O₂→CO₂. The reformate g removed of the CO gas is supplied through the first reformate transport line 16 to the fuel cell stack 3.

In the burner section 25, the combusted exhaust gas q is produced by combusting the combustion fuel n or the off-gas f. The combusted exhaust gas q is discharged through the combusted exhaust gas passage 28 outside the fuel processing apparatus 2, and transported with the combusted exhaust gas transport line 29. When the flow rate of the combustion air k4 is set to be greater than the flow rate of the combustion fuel n or the off-gas f sent to the burner section 25, extinction in the burner section 25 occurs, and the combustion fuel n or the off-gas f that has not combusted in the burner section 25 flows, together with the combusted exhaust gas q, through the combusted exhaust gas passage 28, passes through the combustion catalyst section 26 while flowing through the combusted exhaust gas passage 28, is combusted with the combustion catalyst in the combustion catalyst section 26 to become the combusted exhaust gas q, flows further through the combusted exhaust gas passage 28, is discharged outside the fuel processing apparatus 2, and is transported with the combusted exhaust gas transport line 29. Because the combustion catalyst section 26 is located in the vicinity of the shift converter catalyst section 22 and the selective oxidation catalyst section 23, the shift converter catalyst section 22 and the selective oxidation catalyst section 23 can be heated up efficiently with the heat produced by combustion in the combustion catalyst section 26.

The stack air k3 transported with the blower 41A for the stack air is supplied through the stack air supply section 19 to the fuel cell stack 3. The control valve 42 for the stack air provided in the stack air supply section 19, receiving a flow rate control signal i1 from the control section 4, is controlled to a specified opening to flow the stack air k3 at a flow rate corresponding to the flow rate control signal i1. The flow rate of the stack air k3 is measured with the flowmeter 43 for the stack air. The measured flow rate is sent as a flow rate signal i5 to the control section 4.

The fuel cell stack 3 causes electrochemical reaction between the reformate g and the stack air k3 to produce electricity which is supplied to the load 5.

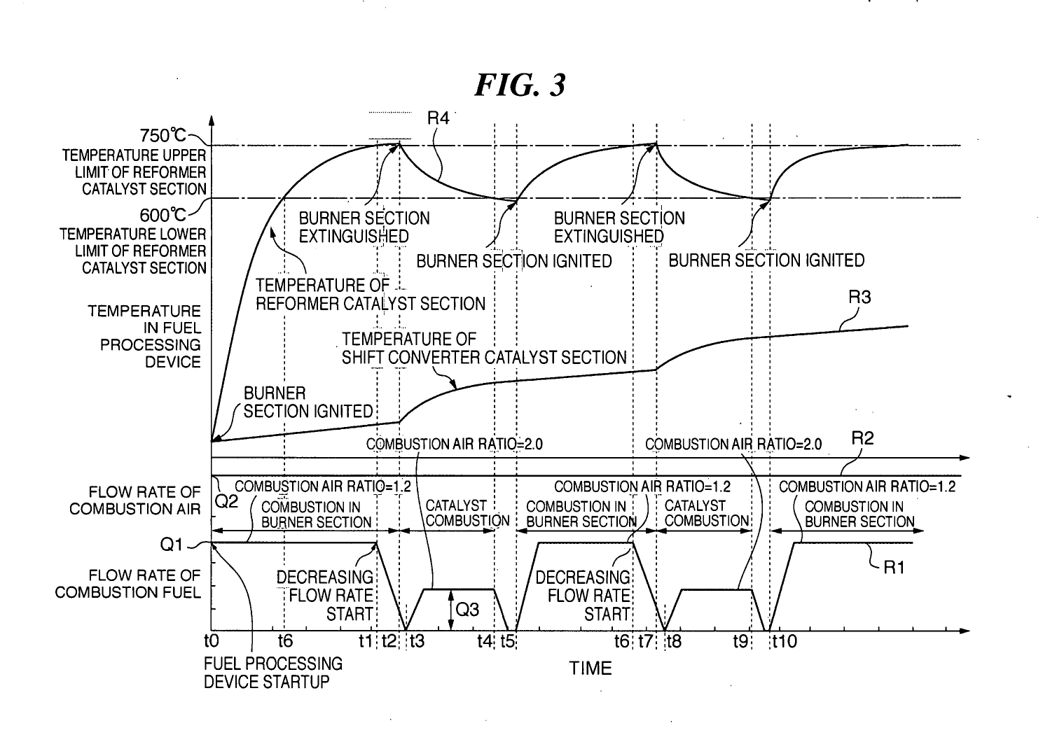

Referring to FIG. 3, and referring to FIG. 1 as appropriate, the method of startup operation of the fuel cell power generation system 1 by means of the control section 4 is described. In FIG. 3, the vertical axis indicates: a flow rate of the combustion fuel n, a flow rate of the combustion air k4, and a temperature within the fuel processing apparatus (temperatures of the shift converter catalyst section 22 and the reformer catalyst section 21). The horizontal axis indicates lapse of time. In FIG. 3, the line R1 indicates the change with time in the flow rate of the combustion fuel n detected with the flowmeter 43 for the combustion fuel (See FIG. 2). The straight line R2 indicates the change with time in the flow rate of the combustion air k4 detected with the flowmeter 43 for the combustion air (See FIG. 2). The curve R3 indicates the change with time in the temperature of the shift converter catalyst section 22 detected with the temperature detector 34. The curve R4 indicates the change with time in the temperature of the reformer catalyst section 21 detected with the temperature detector 33. As described below, the control section 4 controls the system during the startup thereof, for example.

The combustion fuel n and the combustion air k4 are supplied to the burner section 25. At the time t0, the supplied amounts of the combustion fuel n and the combustion air k4 reach stationary values, the combustion fuel n reaching Q1 [NL/min] and the combustion air k4 reaching Q2 [NL/min]. Also at the time t0, an igniter 36 is activated to cause combustion in the burner section 25. The values Q1 [NL/min] and Q2 [NL/min] are typically ones that make a combustion air ratio 1.2. When the reformer fuel h is not supplied to the reformer catalyst section 21 during the startup as in this embodiment, the flow rate of a combustible gas that makes the combustion air ratio 1.2 is calculated from only the flow rate of the combustion fuel n. However, when the reformer fuel h is supplied also to the reformer catalyst section 21, the flow rate Q1 [NL/min] is the sum of flow rates of the combustion fuel n and the reformer fuel h. When the reformer fuel h is supplied, the selective oxidation air k1 is also supplied.

As combustion occurs in the burner section 25, the temperature of the reformer catalyst section 21 rises rapidly, while the temperature of the shift converter catalyst section 22 rises slowly. At the time t0′ (10 minutes after t0, for example), the temperature of the reformer catalyst section 21 reaches the lower limit of the reformer catalyst section (typically 600° C., for example). The lower limit of the reformer catalyst section is a temperature for reforming that enables the production of the reformate g which contains an amount of hydrogen required for generating electricity within a short period of time after the reformer fuel h and the reformer process water (not shown) start to be supplied to the reformer catalyst section 21. Incidentally, the reason for making the combustion air ratio 1.2 is to make the air ratio great enough so that no imperfect combustion occurs due to uneven flow.

At the time t1 (two minutes after t0′, for example), the temperature of the reformer catalyst section 21 reaches the upper limit of the reformer catalyst section (typically 750° C., for example). The upper limit of the reformer catalyst section is the temperature at which the reformer catalyst will be damaged (catalyst is sintered). The temperature of the shift converter catalyst section 22 continues to rise gradually.

At the time t1, it is detected that the temperature of the reformer catalyst section 21 has reached the upper limit, and then the flow rate of the combustion fuel n starts to be decreased, while the flow rate of the combustion air k4 is not changed but maintained at the flow rate of Q2 [NL/min].

At the time t2 (one minute after t1, for example), extinction occurs in the burner section 25 due to too low an air ratio.

At the time t3 (10 seconds after t2, for example), the flow rate of the combustion fuel n becomes 0 (zero). At the same time the flow rate becoming 0 (zero), the flow rate of the combustion fuel n is increased again to Q3 [NL/min] (about half the Q1), while the flow rate of the combustion air k4 is maintained still at Q2 [NL/min]. The flow rate Q3 [NL/min] is, as described above, typically the one that results in the air ratio of 2.0. The combustion fuel n is not combusted in the burner section 25 and flows together with the combustion air k4 from the burner section 25 through the combusted exhaust gas passage 28 and through the combustion catalyst section 26 where combustion reaction of the combustion fuel n starts using the combustion catalyst. Because the combustion catalyst section 26 is located in the vicinity of the shift converter catalyst section 22, the temperature of the shift converter catalyst section 22 rises rapidly. At the time t2, because the combustion in the burner section 25 is halted, the temperature of the reformer catalyst section 21 starts descending. The temperature of the shift converter catalyst section 22 rises rapidly, while the temperature of the reformer catalyst section 21 falls gradually. Incidentally, the reason for making the air ratio 2.0 is that this air ratio is required to carry out perfect catalyst combustion in the combustion catalyst section 26 for preventing noncombusted gas from being produced and released to the ambience.

At the time t4, the temperature of the reformer catalyst section 21 falls to the lower limit (600° C.). That the temperature of the reformer catalyst section 21 has reached the lower limit is detected, and the flow rate of the combustion fuel n is controlled to become 0 (zero). The combustion air k4 is maintained at Q2 [NL/min]. The combustion fuel or the like flowing through the combusted exhaust gas passage 28 are combusted in the combustion catalyst section 26.

At the time t5, after a specified time (30 seconds, for example) from the time t4, or after combustible gas in the burner section 25 is purged, the igniter 36 is activated, and the combustion fuel n of the flow rate Q1 [NL/min] is supplied to the burner section 25. The flow rate of the combustion air k4 supplied to the burner section 25 is maintained at Q2 [NL/min].

After the time t5, the control performed from the time t1 to the time t5 is repeated until the temperature of the shift converter catalyst section 22 rises beyond a specified value (250° C., for example). After that, the operation moves on from a startup mode to a normal mode, the supply of the combustion fuel n is stopped, and the reformer fuel h is supplied in place of the combustion fuel n. Incidentally, the specified temperature herein is the one at which the shift converter catalyst becomes functionally active enough to reduce CO concentration in the reformate g in an amount necessary for generating electricity when the reformer fuel h is supplied.

According to the fuel cell power generation system 1 of the first embodiment, the following process is repeated until the temperature of the shift converter catalyst section 22 reaches a specified value (250° C., for example): The flow rate of the combustion fuel n is reduced to 0 (zero) when the temperature of the reformer catalyst section 21 reaches the upper limit; after causing extinction in the burner section 25 due to too high an air ratio, the combustion fuel n is supplied until the temperature of the reformer catalyst section 21 reaches the lower limit; the combustion fuel n is caused to start combustion in the combustion catalyst section 26 to heat the shift converter catalyst section 22 so as to raise the temperature of the shift converter catalyst section 22; and after the temperature of the reformer catalyst section 21 reaches the lower limit, the burner section 25 is ignited to combust the combustion fuel n. Therefore, it is possible: to avoid excessive temperature rise of the reformer catalyst section 21 and the burner section 25 in comparison with the shift converter catalyst section 22; to raise the temperature of the shift converter catalyst section 22 within a short period of time; to raise the temperatures of the respective sections 21, 22, and 23 in the fuel processing apparatus up to values that make it possible to produce the reformate g for generating electricity in the fuel cell stack 3 within a short period of time; to shorten the startup time; and to reduce startup energy consumption. Besides, because no electric heater is used for raising temperature, electric power consumption is reduced during the startup time.

In the conventional fuel processing apparatus, an operation has been practiced in which combustion is maintained with a small flow rate of the reformate or combustion fuel in the burner section until the temperatures of the shift converter catalyst section and the selective oxidation catalyst section reach specified values. The method of raising the temperatures of the shift converter catalyst and the selective oxidation catalyst by this operation is required to prevent excessive temperature rise of the burner section and the reformer catalyst section by reducing (about 10 to 20% of rated flow rate) the turndown ratio (ratio of minimum flow rate to rated (maximum) flow rate) of the combustion fuel or the reformer fuel. Because a small error in the flow rate control of the combustion fuel or the reformer fuel in the small turndown ratio region leads to a great variation in the combustion air ratio, control with a high accuracy is required to prevent extinction, which is inevitably difficult.

With the fuel processing apparatus 2 of this embodiment, the flow rate of the combustion fuel n is set to Q1 [NL/min] during heat-up period of mainly the reformer catalyst section 21 and to Q3 [NL/min] during heat-up period of mainly the shift converter catalyst section 22 after ending the heat-up of the reformer catalyst section 21, so that the turndown ratio (Q3/Q1) can be made as high as 30%. As a result, it is possible to narrow down the flow rate control range and stabilize flow rate control, resulting in the stabilized startup operation.

As described above, it is controlled that: the temperature of the reformer catalyst section 21 is monitored; the burner section 25 is caused to be extinguished when the temperature of the reformer catalyst section 21 reaches the upper limit; the combustion fuel n is prevented from combustion in the burner section 25 while the combustion fuel n is caused to combust in the combustion catalyst section 26; and the burner section 25 is ignited to cause the combustion fuel n to combust in the burner section 25 when the temperature of the reformer catalyst section 21 reaches the lower limit. However, it is alternatively possible to obtain the same effect as with the above embodiment by controlling that: the temperature of the burner section 25 is monitored in place of the temperature of the reformer catalyst section 21; the temperature of the burner section 25 is converted into a temperature signal to be sent to the control section 4; the upper limit of the temperature of the burner section 25 is used in place of the upper limit of the temperature of the reformer catalyst section 21; and the lower limit of the temperature of the burner section 25 is used in place of the lower limit of the temperature of the reformer catalyst section 21. As for another point, from the viewpoint of the material protection, when a difference is present between the temperature of the burner section 25 and the temperature of the reformer catalyst section 21, in some cases restriction by the upper limit of the temperature of the burner section is stricter than by the reformer temperature. In that case, it is effective for the control to use the temperature of the burner section 25 rather than the temperature of the reformer catalyst section 21. It is also possible to use both the upper limit of the combustion temperature and the upper limit of the reformer temperature as restrictions.

While the above control is conducted until the temperature of the shift converter catalyst section 22 reaches a specified value by detecting the temperature of the shift converter catalyst section 22, the above control may be alternatively conducted until the temperature of the selective oxidation catalyst section 23 reaches a specified value (140° C., for example) by detecting the temperature of the selective oxidation catalyst section 23 with the temperature detector 35. In this way, the same effect as with the above embodiment is obtained. The specified value herein is the temperature at which the selective oxidation reaction starts promptly when the reformate and the selective oxidation air are supplied to the selective oxidation catalyst and the catalyst activity is maintained so that CO is removed securely. Incidentally, because the combustion catalyst section 26 is located in the vicinity of the selective oxidation catalyst section 23, the selective oxidation catalyst section 23 can be heated up promptly by the combustion in the combustion catalyst section 26.

As has been described, the burner section 25 is caused to extinguish when the temperature of the reformer catalyst section 21 reaches the upper limit. However, it may be alternatively made that the burner section 25 is caused to extinguish either when the temperature of the reformer catalyst section 21 reaches the upper limit or when the temperature of the combustion catalyst section 26 detected with the temperature detector 32 reaches the lower limit. Also, thereafter, the burner section 25 is ignited when the temperature of the reformer catalyst section 21 reaches the lower limit. However, it may be alternatively made that the burner section 25 is ignited either when the temperature of the reformer catalyst section 21 reaches the lower limit or when the temperature of the combustion catalyst section 26 reaches the upper limit. Here, the upper limit of the combustion catalyst section 26 is the upper limit temperature for use, about 600° C., that does not cause the combustion catalyst to deteriorate. The lower limit temperature of the combustion catalyst section 26 is the one, about 300° C., at which the catalyst combustion reaction can be started promptly when the combustible gas and air are supplied to the combustion catalyst.

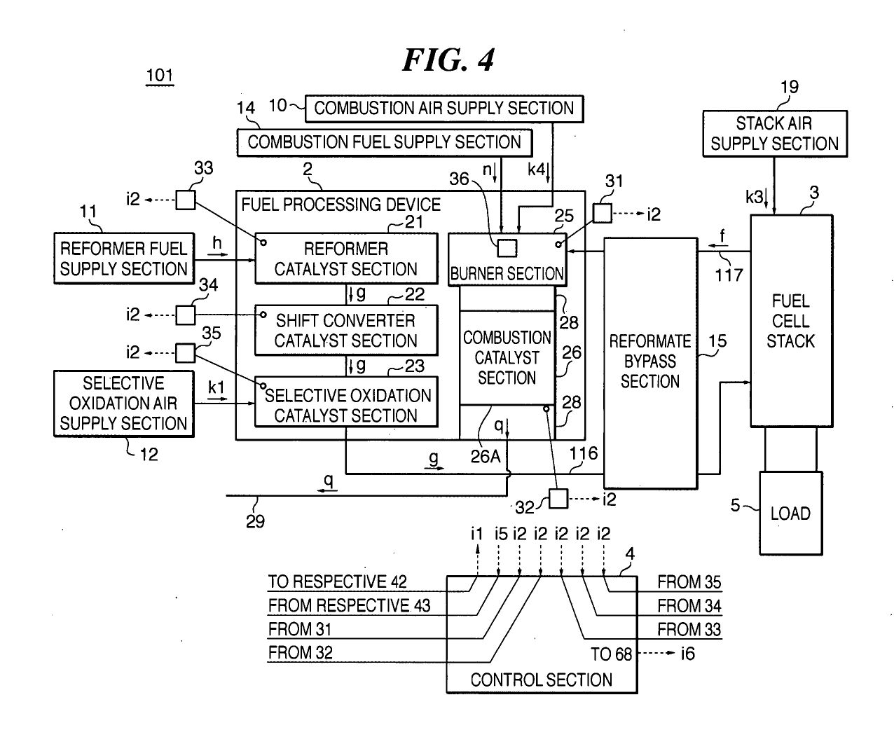

FIG. 4 is a block diagram, showing a configuration of a fuel cell power generation system 101 of a second embodiment according to the invention. Only the points that are different in configuration from the aforementioned fuel cell power generation system 1 of the first embodiment are described below.

The fuel cell power generation system 101 is not provided with a combustion fuel supply section for supplying a combustion fuel to the burner section 25. The fuel cell power generation system 101 comprises: a first reformate transport line 116, a first off-gas transport line 117, and a reformate bypass section 15. The reformate bypass section 15 interconnects the first reformate transport line 116 and the first off-gas transport line 117 to permit the flow of whole or a part of the reformate g from the first reformate transport line 116 to the first off-gas transport line 117, bypassing the fuel cell stack 3.

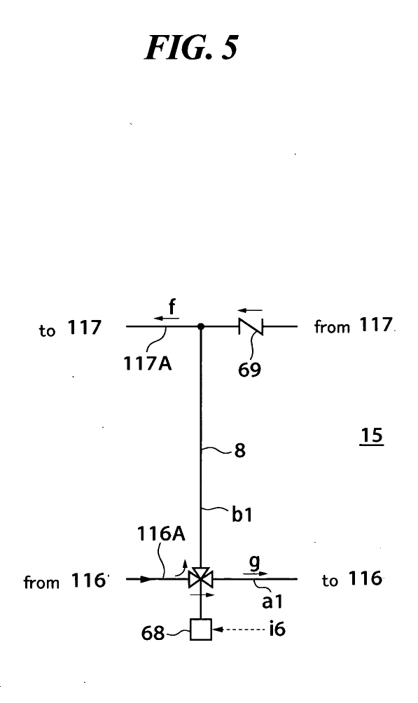

As shown in FIG. 5, the reformate bypass section 15 comprises: a second reformate transport line 116A having a three-way valve 68 for transporting the reformate g; a second off-gas transport line 117A having a check valve 69 for transporting the off-gas f; and a reformate transport bypass line 8 branching off from the second reformate transport line 116A through the three-way valve 68 and connected to the second off-gas transport line 117A for transporting the reformate g.

The second reformate transport line 116A is connected, at its both ends, to the first reformate transport line 116 to permit the flow of the reformate g coming from the fuel processing apparatus 2 through the first reformate transport line 116, again through the first reformate transport line 116, to the fuel cell stack 3, when not bypassing the fuel cell stack 3. The second off-gas transport line 117A is connected, at its both ends, to the first off-gas transport line 117 to permit the flow of the off-gas f coming from the fuel cell stack 3 through the first off-gas transport line 117, again through the first off-gas transport line 117, to the fuel cell stack 3. The reformate transport bypass line 8 is connected to the second off-gas transport line 117A on the downstream side of the check valve 69.

When a switchover signal i6 is sent from the control section 4 to the three-way valve 68, it switches the three-way valve 68 to flow the reformate g sent from the fuel processing apparatus 2 toward the fuel cell stack 3 (on a1 side) or toward the first off-gas transport line 117 (toward the burner section, on b1 side). The check valve 69 permits the off-gas f to flow from the fuel cell stack 3 toward the burner section 25 and prevents the flow in the opposite direction. The check valve 69 also prevents the reformate g flowing into the first off-gas transport line 117 from flowing into the fuel cell stack 3, and permits it flowing only into the burner section 25. By controlling the flow rate of the reformer fuel h, the flow rate of the reformate g is dependently controlled; as the flow rate of the reformer fuel h increases, the flow rate of the reformer fuel h increases, and vice versa.

Next, with reference to FIGS. 4 and 5, the functions of the fuel cell power generation system 101 are described only in terms of differences from the fuel cell power generation system 1.

Before the startup operation, the three-way valve 68 is switched, with a switchover signal i6 coming from the control section 4, to a position permitting the flow of a fluid flowing on b1 side and preventing it from flowing on a1 side. Although the fluid flowing on b1 side flows toward the burner section 25, it does not flow to the fuel cell stack 3 because it is stopped with the check valve 69. When the fuel cell power generation system 101 is started up with the temperature of the reformer catalyst section 21 being lower than the lower limit (600° C., for example) for causing the reformer reaction with the reformer catalyst, the reformate g is not produced from the reformer fuel h in the reformer catalyst section 21 even if the reformer fuel h is supplied from the reformer fuel supply section 11 to the fuel processing apparatus 2, and the reformer fuel h is directly sent to the burner section 25 and is combusted there. When the combustion occurs in the burner section 25 and then the temperature of the reformer catalyst section 21 rises and exceeds the value at which the reformer reaction occurs with the reformer catalyst, the reformate g is produced from the reformer fuel h, sent to the burner section 25, and combusted there.

In a transition period from the startup to normal operation, the three-way valve 68 is typically switched to the position for permitting fluid flowing on a1 side while preventing it from flowing on b1 side, so that the reformate g is supplied only to the fuel cell stack 3 for electric generation. When assist-combustion in the burner section 25 becomes necessary in normal operation, the supply amount of the reformer fuel h is increased to increase the flow rate of the reformate g. Additionally, the three-way valve 68 is partially opened so that a part of the reformate g flows on a1 side and the remainder (increased portion) flows on b1 side.

As the reformer fuel h, the reformate g or the off-gas f is combusted in the burner section 25, the combusted exhaust gas q is produced which flows through the combusted exhaust gas passage 28, is discharged out of the fuel processing apparatus 2, and is transported through the combusted exhaust gas transport line 29. If the flow rate of the combustion air k4 is in excess relative to the flow rate of the reformer fuel h, the reformate g or the off-gas f sent as the combustion fuel to the burner section 25 (air ratio is too great), extinction of the reformer fuel h, the reformate g or the off-gas f occurs in the burner section 25, and the reformer fuel h, the reformate g or the off-gas f not combusted in the burner section 25 flows through the combusted exhaust gas passage 28, passes through the combustion catalyst section 26 while flowing through the combusted exhaust gas passage 28, is combusted in the combustion catalyst section 26 using the combustion catalyst to become the combusted exhaust gas q, further flows through the combusted exhaust gas passage 28, is discharged out of the fuel processing apparatus 2, and is transported through the combusted exhaust gas transport line 29. Because the combustion catalyst section 26 is located in the vicinity of the shift converter catalyst section 22 and the selective oxidation catalyst section 23, the shift converter catalyst section 22 and the selective oxidation catalyst section 23 can be heated up efficiently with the heat of combustion in the combustion catalyst section 26.

Next, the startup operation method of the fuel cell power generation system 101 through the control section 4 is described. The description of the startup operation method for the fuel cell power generation system 101 is understood by referring to FIG. 3 with partial changes of the description and by changing the above description of the startup operation method of the fuel cell power generation system 1 so as that the reformer fuel h is supplied under flow rate control to the fuel processing apparatus 2 instead of supplying the combustion fuel n under flow rate control to the burner section 25, and the reformate g (the reformer fuel h when the temperature of the reformer catalyst section 21 is lower than the lower limit (600° C.) suitable for the reformer reaction) is supplied to the burner section 25. Main points of changing the description are described below.

In the above description of the startup operation method of the fuel cell power generation system 1, the description that the vertical axis of FIG. 3 indicates the flow rate of “the combustion fuel n” is to be changed to read that it indicates the flow rate of “the reformer fuel h supplied as the combustion fuel.” The description that the line R1 indicates the change with time in the flow rate of “the combustion fuel n” detected with the flowmeter 43 “for the combustion fuel” (See FIG. 2) is to be changed to read that it indicates the change with time in the flow rate of “the reformer fuel h” detected with the flowmeter 43 “for the reformer fuel” (See FIG. 2). The description that “the combustion fuel n” and the combustion air k4 are supplied to the burner section 25 is to be changed to read that “the reformer fuel h, the reformate g or the off-gas f” and the combustion air k4 are supplied to the burner section 25.

The description that at the time t0, the supplied amounts of “the combustion fuel n” and the combustion air k4 reach stationary values, “the combustion fuel n” reaching “Q1” [NL/min] and the combustion air k4 reaching “Q2” [NL/min] is to be changed to read that at the time t0, the supplied amounts of “the reformer fuel h” and the combustion air k4 reach stationary values, “the reformer fuel h” reaching “Q1′” [NL/min] and the combustion air k4 reaching “Q2′” [NL/min]. Thereafter, “Q1” to be changed to read “Q1′” and “Q2” to be changed to read “Q2′.” The description that when the reformer fuel h is not supplied the air ratio is calculated from only the combustion fuel n does not apply. Incidentally, when the flow rate of the reformer fuel h is Q1′ [NL/min] and the flow rate of the combustion air k4 is Q2′[NL/min], the combustion air ratio is 1.2. When the flow rate of the reformer fuel h is Q3′ [NL/min] and the flow rate of the combustion air k4 is Q2′ [NL/min], the combustion air ratio is 2.0.

The description that at the time t1, the flow rate of “the combustion fuel n” starts to be decreased is to be changed to read that at the time t1, the flow rate of “the reformer fuel h” starts to be decreased. The description that at the time t3, the flow rate of “the combustion fuel n” becomes 0 (zero) is to be changed to read that at the time t3, the flow rate of “the reformer fuel h” becomes 0 (zero).

In the description on the phenomenon during the period between the time t3 and time t4 that “the combustion fuel n” is not combusted in the burner section 25, flows together with the combustion air k4 from the burner section 25 through the combusted exhaust gas passage 28 and through the combustion catalyst section 26 where combustion reaction of the combustion fuel n starts using the combustion catalyst, “the combustion fuel n” is to be changed to read “the reformer fuel h.”

The description related to the time t4 that the flow rate of “the combustion fuel n” is controlled to become 0 (zero) is to be changed to read that the flow rate of “the reformer fuel h” is controlled to become 0 (zero). The description that “the combustion fuel or the like” are combusted in the combustion catalyst section 26 is to be changed to read that “the reformate or the like” are combusted in the combustion catalyst section 26. The description that “the combustion fuel n” is supplied to the burner section 25 is to be changed to read that “the reformer fuel h” is supplied to the burner section 25.

With the fuel cell power generation system 101 of the second embodiment described above, extinction is caused to occur in the burner section 25 during the startup, the reformer fuel h or the reformate g is combusted in the burner section 25, before the extinction, to heat and raise the temperature of the reformer catalyst section 21, and after the extinction the reformer fuel h or the reformate g that has not been combusted in the burner section 25 is combusted in the combustion catalyst section 26 to heat and raise the temperature of the shift converter catalyst section 22. Therefore, it is possible to avoid excessive temperature rise of the reformer catalyst section 21 and also to supply a large amount of the reformer fuel h. As a result, it is possible to startup with stability, to shorten the startup time, and to reduce the startup energy consumption.

Because the reformate g produced from the reformer fuel h is supplied as a combustion fuel to the burner section 25, the combustion fuel supply section is not required, and the configuration may be made simple if a single material such as city gas is used. Because the reformate g may be used as a heating medium for heating the shift converter catalyst section 22, it is possible to further shorten the startup time and to further reduce the startup energy consumption.

Because the reformer fuel h is supplied from the startup time, it is possible to send the reformate g to the fuel cell stack 3 from the startup time. In that case, partial load electric generation with the fuel cell stack 3 is made possible in an early stage. If the temperature of the shift converter catalyst section 22 or the selective oxidation catalyst section 23 falls by some cause during electric generation (normal operation), it is possible to raise again the temperature of the shift converter catalyst section 22 or the selective oxidation catalyst section 23 through combusting the off-gas f with the combustion catalyst by supplying the combustion air k4 too much for a short period of time to cause the burner section 25 to be extinguished for a short period of time. Or it is possible to do so by repeating the above operation.

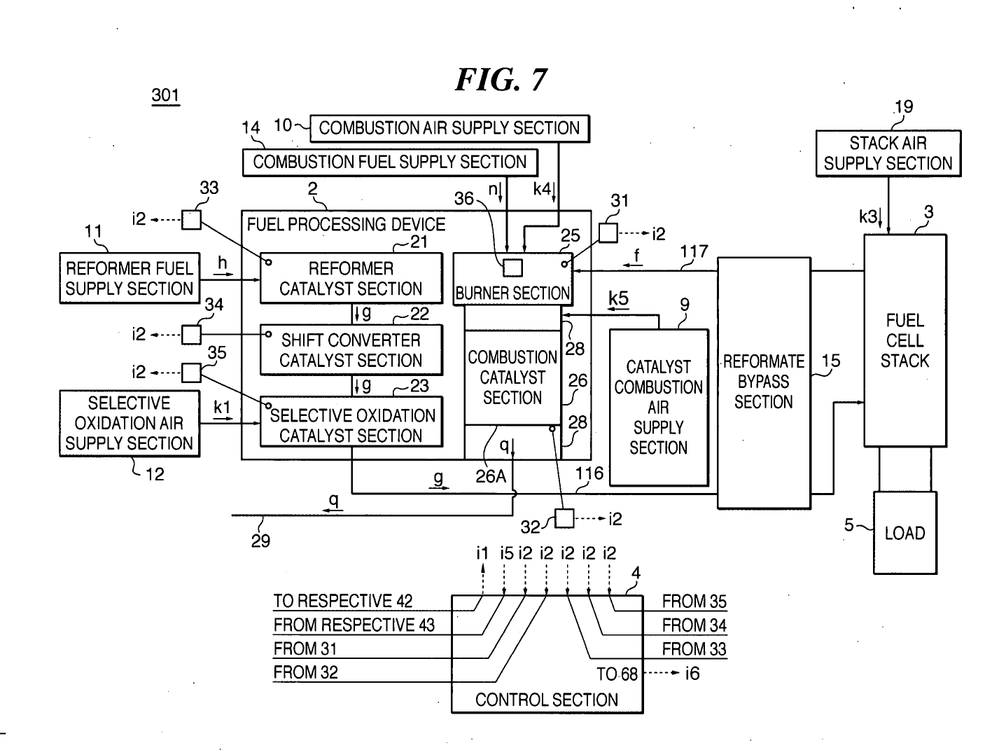

In the case the fuel cell power generation system 101 is provided with the catalyst combustion air supply section 9 (See FIG. 7) for supplying the catalyst combustion air k5 for the combustion catalyst on the upstream side of the combustion catalyst section 26 in the combusted exhaust gas passage 28, it is possible to raise again the temperature of the shift converter catalyst section 22 and the selective oxidation catalyst section 23 through combusting the off-gas f with the combustion catalyst by supplying too little the combustion air k4 to cause imperfect combustion in the burner section 25 and by supplying the catalyst combustion air k5 (See FIG. 7).

FIG. 6 is a block diagram, showing a configuration of a fuel cell power generation system 201 of a third embodiment according to the invention. Only the points are described below that are different in configuration from the fuel cell power generation system 1 of the first embodiment.

The fuel cell power generation system 201 is provided with the catalyst combustion air supply section 9, not provided in the fuel cell power generation system 1, for supplying the catalyst combustion air k5. The catalyst combustion air k5 is one of the utility fluids. The catalyst combustion air supply section 9 is connected to the upstream side of the combustion catalyst section 26 in the combusted exhaust gas passage 28 to supply the catalyst combustion air k5 to the combustion catalyst section 26.

As shown in FIG. 2, the catalyst combustion air supply section 9 is configured by including: the blower 41A that is connected to the supply source 40 for supplying the catalyst combustion air k5 and functions as a fluid pressurizing device for pressurizing the catalyst combustion air k5; the control valve 42 as a fluid flow rate controller for controlling the flow rate of the catalyst combustion air k5; and a piping 44 interconnecting the above components. A flow rate control signal i1 for controlling the flow rate through the control valve 42 is sent from the control section 4 (See FIG. 6) to the control valve 42. A flow rate signal i5 representing the measured flow rate is sent from the flowmeter 43 to the control section 4.

Next, with reference to FIG. 6, the functions of the fuel cell power generation system 201 are described. Only the functional differences from the fuel cell power generation system 1 are described. The catalyst combustion air k5 is supplied to the combusted exhaust gas passage 28 when imperfect combustion is caused to occur in the burner section 25 at the time of starting up the fuel cell power generation system 201, so that the combustion fuel n that has not been combusted in the burner section 25 is combusted in the combustion catalyst section 26. The control valve 42 for the catalyst combustion air k5 provided in the catalyst combustion air supply section 9, receiving the flow rate control signal i1 from the control section 4, is controlled to a specified opening to flow the catalyst combustion air k5 at a flow rate corresponding to the flow rate control signal i1. The flow rate of the catalyst combustion air k5 is measured with the flowmeter 43 for the catalyst combustion air. The measured flow rate is sent as a flow rate signal i5 to the control section 4.

Next, also with reference to FIG. 6, the startup operation method of the fuel cell power generation system 201 through the control section 4 is described. The igniter 36 provided in the burner section 25 is activated, the flow rate of the combustion fuel n is set to Q1 [NL/min], the flow rate of the combustion air k4 is set to Q2 [NL/min], and the burner section 25 is ignited. Q1 [NL/min] and Q2 [NL/min] are determined to result in the combustion air ratio of 1.2.

(1) The catalyst combustion air k5, at a flow rate of Q4 [NL/min], is supplied to the combusted exhaust gas passage 28. (2) The flow rate of the combustion air k4 is decreased to Q5 [NL/min] so that the combustion air ratio in the burner section 25 results in 0.75. Imperfect combustion occurs in the burner section 25. Because the air ratio is 0.75, imperfect combustion occurs in the burner section 25 without causing extinction.

(3) At this time, the flow rate Q4 [NL/min] of the catalyst combustion air k5 is set so that the air ratio in the combustion catalyst section 26 results in 2.0. (4) When the temperature at the outlet 26A of the combustion catalyst section 26 detected with the temperature detector 32 reaches a certain upper limit (600° C., for example), the flow rate of the combustion air k4 is increased up to Q2 [NL/min] to cause perfect combustion to occur in the burner section 25. Because the combustion in the combustion catalyst section 26 becomes unnecessary, the flow rate of the catalyst combustion air k5 is set to 0 (zero).

(5) When the outlet temperature of the combustion catalyst section 26 falls to a certain lower limit (300° C., for example), the catalyst combustion air k5 is supplied at the flow rate of Q4 [NL/min] and the flow rate of the combustion air k4 is reduced to Q5 [NL/min] so that the air ratio in the burner section 25 results in 0.75. (6) The above steps from (1) to (5) are repeated until the temperature of the shift converter catalyst section 22 reaches a specified value (250° C., for example). The specified value herein is the same as that described in relation to the first embodiment.

With the fuel cell power generation system 201 of the third embodiment described above, imperfect combustion is caused to occur in the burner section 25 during the startup so that the reformer catalyst section 21 is heated to a higher temperature by combusting a part of the combustion fuel n in the burner section 25 and the catalyst combustion air k5 is supplied to the combustion catalyst section 26 to combust the combustion fuel n that has not been combusted in the burner section 25 to heat the shift converter catalyst section 22 to a higher temperature. Therefore, it is possible to avoid excessive temperature rise of the reformer catalyst section 21, and to supply a large amount of the combustion fuel n to shorten the startup time. Besides, because the turndown ratio of the flow rate of the combustion fuel n can be increased (50%, for example), the flow rate of the combustion fuel n is controlled in a stabilized manner.

FIG. 7 is a block diagram, showing a configuration of a fuel cell power generation system 301 of the fourth embodiment according to the invention. Only the points are described below that are different in configuration from the fuel cell power generation system 201 of the third embodiment.

The fuel cell power generation system 301 is provided with the reformate bypass section 15 that is not provided in the fuel cell power generation system 201. The reformate bypass section 15 interconnects the first reformate transport line 116 and the first off-gas transport line 117 to permit whole or a part of the reformate g to flow from the first reformate transport line 116 to the first off-gas transport line 117, bypassing the fuel cell stack 3. Incidentally, the flow rate of the reformate g produced in the fuel processing apparatus 2 may be controlled by controlling the flow rate of the reformer fuel h supplied from the reformer fuel supply section 11.

The details of the reformate bypass section 15 is shown in FIG. 5 and because its configuration is described in relation to the second embodiment, the description is not repeated here.

Next, the functions of the fuel cell power generation system 301 are described below in reference to FIGS. 7 and 5. Only points that are different in functions from the above-mentioned fuel cell power generation system 201 are described.

Before starting up, the three-way valve 68 is switched with a switchover signal i6 to a position for permitting the reformate flowing on b1 side and preventing it from flowing on a1 side.

During the startup, the combustion fuel n only is supplied from the combustion fuel supply section 14 to the burner section 25 (exclusive combustion of the combustion fuel n). When the temperature of the reformer catalyst during the startup exceeds a lower limit (600° C.) suitable for the reformer reaction, the combustion fuel n only may remain to be supplied to the burner section 25(exclusive combustion of the combustion fuel n). However, it may also be made that, in addition to supplying the combustion fuel n to the burner section 25, the reformer fuel h is supplied to the fuel processing apparatus 2 to send the reformate g produced in the fuel processing apparatus 2 to the burner section 25 through the reformate bypass section 15 (mixed combustion of the combustion fuel n and the reformate g).

During the startup, to cause imperfect combustion of the combustion fuel n (exclusive combustion) or mixture of the combustion fuel n and the reformate g (mixed combustion), the air ratio may be made too small by decreasing the flow rate of the combustion air k4 (in this case, the flow rate of the combustion fuel n (exclusive combustion) or the total flow rate of the combustion fuel n and the reformer fuel h (mixed combustion) may be made constant). Or, the air ratio may be made too small by increasing the flow rate of the combustion fuel n (exclusive combustion) or the total flow rate of the combustion fuel n and the reformer fuel h (mixed combustion) (in this case, the flow rate of the combustion air k4 may be made constant).

It is possible to cause imperfect combustion in the burner section 25 by making the air ratio too small, and to combust the combustion fuel n (exclusive combustion), or the combustion fuel n and the reformate g (mixed combustion), which have not been combusted in the burner section 25, in the combustion catalyst section 26 by supplying the catalyst combustion air k5 from the catalyst combustion air supply section 9 to the combustion catalyst section 26.

In the mixed combustion, at first only the combustion fuel n is supplied at a constant flow rate to the burner section 25 and the flow rate of the combustion air k4 is made constant (combustion air ratio at 1.2). After that, when the temperature of the reformer catalyst section 21 exceeds the lower limit (600° C.) suitable for the reformer reaction, supply of the reformer fuel h is started, and the reformate g is supplied through the reformate bypass section 15 to the burner section 25, bypassing the fuel cell stack 3.

With the fuel cell power generation system 301 of the fourth embodiment described above, imperfect combustion is caused to occur in the burner section 25 during the startup so that the reformer catalyst section 21 is heated to a higher temperature by combusting a part of the reformer fuel h or the reformate g in the burner section 25, the catalyst combustion air k5 is supplied to the combustion catalyst section 26 to combust in the combustion catalyst section 26 the reformer fuel h or the reformate g that has not been combusted in the burner section 25. Because the combustion catalyst section 26 is located in the vicinity of the shift converter catalyst section 22 and the selective oxidation catalyst section 23, the shift converter catalyst section 22 and the selective oxidation catalyst section 23 can be heated up to a higher temperature. Therefore, it is possible to avoid excessive temperature rise of the reformer catalyst section 21. Because the combustion fuel n or the reformer fuel h can be supplied in a large amount, it is possible to startup in a stabilized manner, to shorten the startup operation time, and to reduce the startup energy consumption. Because the reformate g can be used as a heat medium for heating the shift converter catalyst section 22 and the selective oxidation catalyst section 23, it is possible to further shorten the startup time and to further reduce the startup energy consumption.

In the case the temperatures of the shift converter catalyst section 22 and the selective oxidation catalyst section 23 decreases during electric generation (in normal operation) by some cause, it is possible to raise again the temperature of the shift converter catalyst section 22 and the selective oxidation catalyst section 23 as follows: Imperfect combustion is caused to occur in the burner section 25 by supplying the combustion air k4 at a too little flow rate. Then the combustion fuel n, the reformate g, or the off-gas f that has not been combusted in the burner section 25 is combusted using the combustion catalyst in the combustion catalyst section 26 by supplying there the catalyst combustion air k5.

It is described above that, in this embodiment, when the mixed combustion is made in the burner section 25 during the startup using the combustion fuel n and the reformate g, the reformate g is sent to the burner section 25 through the reformate bypass section 15, bypassing the fuel cell stack 3. However, the reformate g maybe sent, not through the reformate bypass section 15, to the fuel cell stack 3. In this case, because the reformer fuel h is supplied to the fuel cell stack 3 from the startup time, partial load electric generation with the fuel cell stack 3 is made possible in an early stage.

Next, a fuel processing method according to another embodiment of the invention is described.

With reference to FIG. 4, for example, this method may comprise: a reformer step of reforming a hydrocarbon-based fuel h into a reformate g containing hydrogen as its main ingredient; a shift converter step of shift-converting carbon monoxide contained in the reformate g; a selective oxidation step of selectively oxidizing carbon monoxide contained in the reformate g after the shift converter step; a first combustion step of combusting a combustion fuel, using combustion air k4, to provide heat required for the reformer step; and a second combustion step of combusting, using the combustion air k4, the combustion fuel that has not been combusted in the first combustion step, to provide heat required for the shift converter step or the selective oxidation step; wherein

(1) in the first combustion step, the combustion fuel is the reformate g produced from the hydrocarbon-based fuel h in the reformer step,

(2) in the first combustion step, extinction is caused to occur by increasing the flow rate of the combustion air k4 or decreasing the flow rate of the combustion fuel to end the first combustion step and then, the second combustion step is started to combust the combustion fuel using a combustion catalyst, and

(3) next, the supply of the combustion fuel is halted, the supply of the combustion air k4 is maintained, and then, the first combustion step is started by resuming the supply of the combustion fuel.

Moreover, the fuel processing method may be one in which the above steps described in (2) above and later are repeated.

The above configuration makes it possible to avoid excessive temperature rise in the reformer step and also possible to raise the temperature in the shift converter step or the selective oxidation step within a short period of time by adjusting the combustion heat amount given in the reformer step as necessary heat for the reformer step in the first combustion step, and the combustion heat amount given in the shift converter step as necessary heat for the shift converter step in the second combustion step or the combustion heat amount given in the selective oxidation step as necessary heat for the selective oxidation in the second combustion step.

Moreover, because the combustion fuel is the reformate g, the reformate g may be supplied during the startup in the first combustion process to supply heat in the reformer step, so that the hydrocarbon-based fuel h needs not be supplied. This makes it possible, when the fuel processing apparatus 2 (FIG. 4) is employed where the first combustion step is carried out in the burner section 25 (FIG. 4), to use the supply section for supplying the combustion fuel to be combusted in the burner section 25 to the burner section 25 for raising the temperature of the reformer catalyst section 21 (FIG. 4) where the reformer reaction is carried out during the startup as a supply section 11 for supplying the hydrocarbon-based fuel h for producing the reformate g, thereby eliminating a supply line for supplying the combustion fuel from outside to the burner section 25.

Because the reformate g is used as the gas for combustion, it is possible to use the reformate g as a heat medium for raising the temperature in the shift converter step or the selective oxidation step during the startup. This means that the reformate g may be used as the heat medium for heating the shift converter catalyst section 22 (FIG. 4) which performs the shift converter step or the selective oxidation catalyst section 23 which performs the selective oxidation step.

Because the hydrocarbon-based fuel h, a fuel for the reformate g, is supplied in an early stage to produce the reformate g from the hydrocarbon-based fuel h, it is possible to generate electricity under partial load in a nearly stage. In the case the temperature in the shift converter step or the selective oxidation step decreases during electric generation (in normal operation) by some cause, it is possible to raise again the temperature in the shift converter step or the selective oxidation step by carrying out the second combustion step. This means that when the temperature of the shift converter catalyst section 22 or the selective oxidation catalyst section 23 lowers, the temperature of the shift converter catalyst section 22 or the selective oxidation catalyst section 23 may be raised again by combusting the reformate with the catalyst in the combustion catalyst section 26 where the second combustion step is carried out.

### INDUSTRIAL APPLICABILITY

According to the invention as has been described, provision of the reformer catalyst section, the shift converter catalyst section, the selective oxidation section, the burner section, the combusted exhaust gas passage, and the combustion catalyst section makes it possible, during the startup, not only to cause combustion of a combustion fuel to occur in the burner section but to cause combustion of a hydrocarbon-based combustion fuel, that has been supplied to but not combusted in the burner section, in the combustion catalyst section using the combustion catalyst. Not only that the reformer catalyst section is heated with the combustion heat in the burner section but that the combustion catalyst section is located in the vicinity of the shift converter catalyst section or the selective oxidation catalyst section enables to heat the shift converter catalyst section or the selective oxidation catalyst section with the heat of combustion in the combustion catalyst section. Therefore, it is possible to raise the temperature of not only the reformer catalyst section but also the shift converter catalyst section or the selective oxidation catalyst section. Consequently, it is possible to shorten the startup time of the fuel processing apparatus and to reduce the startup energy consumption.

Reference numerals and symbols of major components used in the above description are enumerated below: 1, 101, 201, 301: fuel cell power generation system; 2: fuel processing apparatus; 3: fuel cell stack; 4: control section; 5: load; 8: reformate transport bypass line; 9: catalyst combustion air supply section; 10: combustion air supply section; 11: reformer fuel supply section; 12: selective oxidation air supply section; 14: combustion fuel supply section; 15: reformate bypass section; 16, 116: first reformate transport line; 17, 117: first off-gas transport line; 19: stack air supply section; 21: reformer catalyst section; 22: shift converter catalyst section; 23: selective oxidation catalyst section; 25: burner section; 26: combustion catalyst section; 28: combusted exhaust gas passage; 31, 32, 33, 34, 35: temperature detector; 42: control valve; 43: flowmeter; 68: three-way valve; 69: check valve; f: off-gas; h: reformer fuel; i1: flow rate control signal; i2: temperature signal; i5: flow rate signal; g: reformate; k1: selective oxidation air; k3: stack air; k4: combustion air; k5: catalyst combustion air; n: combustion fuel; q: combusted exhaust gas

1. A fuel processing apparatus comprising:
a reformer catalyst section filled with a reformer catalyst for reforming a hydrocarbon-based fuel into a reformate containing hydrogen as a main ingredient thereof;
a shift converter catalyst section filled with a shift converter catalyst for shift-converting carbon monoxide contained in the reformate;
a selective oxidation catalyst section filled with a selective oxidation catalyst for selectively oxidizing carbon monoxide contained in the reformate after the shift-converting;
a burner section for receiving and combusting a combustion fuel, to heat the reformer catalyst section, and discharging a combusted exhaust gas;
a combusted exhaust gas passage through which flows the combusted exhaust gas or the combustion fuel that has not been combusted in the burner section; and
a combustion catalyst section formed in the combusted exhaust gas passage and filled with a combustion catalyst for combusting the combustion fuel, the combustion catalyst section being located in a vicinity of the shift converter catalyst section or the selective oxidation catalyst section.

2. The fuel processing apparatus according to claim 1, wherein the combustion fuel is a hydrocarbon-based fuel and the reformate coming out of the selective oxidation catalyst section; and
the combustion catalyst is capable of combusting the hydrocarbon-based fuel or hydrogen.

3. The fuel processing apparatus according to claim 1, further comprising a catalyst combustion air supply section for supplying combustion air for the combustion catalyst to the upstream side of the combustion catalyst section in the combusted exhaust gas passage.

4. The fuel processing apparatus according to claim 2, further comprising a catalyst combustion air supply section for supplying combustion air for the combustion catalyst to the upstream side of the combustion catalyst section in the combusted exhaust gas passage.

5. The fuel processing apparatus according to claim 1, wherein the combustion catalyst section has: an outlet for the combusted exhaust gas to come out; and a combustion catalyst temperature detecting section disposed at the outlet to detect the temperature of the combustion catalyst.

6. The fuel processing apparatus according to claim 2, wherein the combustion catalyst section has: an outlet for the combusted exhaust gas to come out; and a combustion catalyst temperature detecting section disposed at the outlet to detect the temperature of the combustion catalyst.

7. The fuel processing apparatus according to claim 3, wherein the combustion catalyst section has: an outlet for the combusted exhaust gas to come out; and a combustion catalyst temperature detecting section disposed at the outlet to detect the temperature of the combustion catalyst.

8. A fuel cell power generation system comprising: the fuel processing apparatus according to claim 1; and a fuel cell stack for generating electricity using the reformate having passed through the selective oxidation catalyst section.

9. A fuel cell power generation system comprising: the fuel processing apparatus according to claim 2; and a fuel cell stack for generating electricity using the reformate having passed through the selective oxidation catalyst section.

10. A fuel cell power generation system comprising: the fuel processing apparatus according to claim 3; and a fuel cell stack for generating electricity using the reformate having passed through the selective oxidation catalyst section.

11. A fuel cell power generation system comprising: the fuel processing apparatus according to claim 5; and a fuel cell stack for generating electricity using the reformate having passed through the selective oxidation catalyst section.

12. A fuel processing method, comprising:
a reformer step of reforming a hydrocarbon-based fuel into a reformate containing hydrogen as a main ingredient thereof;
a shift converter step of shift-converting carbon monoxide contained in the reformate;
a selective oxidation step of selectively oxidizing carbon monoxide contained in the reformate after the shift converter step;
a first combustion step of supplying a combustion fuel to a burner section, and combusting the combustion fuel using combustion air in the burner section to provide heat required for the reformer step; and
a second combustion step of combusting, using combustion air, the combustion fuel having passed through but not combusted in the burner section to provide heat required for the shift converter step or the selective oxidation step.

13. The fuel processing method according to claim 12, wherein
in the first combustion step, imperfect combustion is caused to occur by supplying combustion air so that an air ratio results to be smaller than one; and
in the second combustion step, the fuel that has been imperfectly combusted in the first combustion step is combusted perfectly by supplying combustion air so as to result in the air ratio that permits perfect combustion to occur.

14. The fuel processing method according to claim 12, wherein
in the first combustion step, a combustion fuel containing at least one of fluids: an anode off-gas produced in a step of generating electricity using the reformate having undergone the selective oxidation step, the reformate having undergone the selective oxidation step, and a hydrocarbon-based fuel, is supplied, extinction is caused to occur in the first combustion step by increasing the flow rate of combustion air or by decreasing the flow rate of the combustion fuel containing the at least one of the fluids, the first combustion step is stopped and the second combustion step is started, and in the second combustion step the combustion fuel containing the at least one of the fluids is combusted using the combustion catalyst; and then
the supply of the combustion fuel is halted, the supply of the combustion air is maintained, then the supply of the combustion fuel containing the at least one of the fluids is supplied again, and the first combustion step is started.
